(19) United States
(12) Patent Application Publication
(10) Pub. No.: US 2007/0030848 A1
(43) Pub. Date: Feb. 8, 2007

(54) Network communication system

(75) Inventors: Hiroshi Miyata, Tokyo (JP); Shinichi Fujisawa, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/494,870

(22) Filed: Jul. 28, 2006

(30) Foreign Application Priority Data
Jul. 28, 2005 (JP) 2005-219212
Sep. 6, 2005 (JP) 2005-257489
Sep. 6, 2005 (JP) 2005-257490
Nov. 4, 2005 (JP) 2005-320920

(51) Int. Cl. H04L 12/56; H04L 12/28

(52) U.S. Cl. 370/389; 370/401

(57) ABSTRACT

A network communication system includes a ZigBee network being defined based on IEEE 802.15.4, a plurality of IP (Internet Protocol) networks being defined based on IP, and a plurality of gateways available for protocols of the ZigBee network and the IP networks, wherein the plurality of IP networks is connected to the ZigBee network via the plurality of gateways, and a ZigBee frame that is based on the network layer of ZigBee is transmitted in the network communication system, the ZigBee frame storing an IP packet that is based on IP in a part of the ZigBee frame. The gateway includes a hop-limit control section for decrementing a hop number of a packet that passes through the gateway while regarding the ZigBee network as one hop in the IP network.

This application claims foreign priorities based on Japanese Patent application No. 2005-219212 filed Jul. 28, 2005, Japanese Patent application No. 2005-257489 filed Sep. 6, 2005, Japanese Patent application No. 2005-257490 filed Sep. 6, 2005, and Japanese Patent application No. 2005-320920 filed Nov. 4, 2005, the contents of which are incorporated herein by reference in their entireties.

### BACKGROUND OF THE INVENTION

1. Field of the Invention

This invention relates to a network communication system, and more particularly to a system for conducting communications based on IP (Internet Protocol) using a network layer of ZigBee (registered trademark) standardized according to IEEE 802.15.4.

2. Description of the Related Art

FIG. 1 is a conceptual drawing of a ZigBee network. In FIG. 1, a ZigBee network 1 is a network defined in IEEE 802.15.4. ZigBee network devices A to F comply with the standard of IEEE 802.15.4. The ZigBee network defined in IEEE 802.15.4 is provided for connecting ZigBee network devices and has a function of forwarding a packet. Accordingly, the ZigBee network devices A to F can transmit and receive a packet to and from each other. The ZigBee network is intended for allowing the ZigBee network devices A to F to conduct communications with each other and does not assume communications through the IP.

More specifically, the ZigBee network device must follow the ZigBee specifications up to an application layer, but the present invention does not require that the ZigBee network device follow the ZigBee specifications up to the application layer, and may only follow the specifications up to the network layer (or equivalent function on IEEE 802.15.4).

The Internet Engineering Task Force (IETF), has made an attempt to make it possible to use Internet Protocol (IPv6) for the ZigBee network devices.

As shown in FIG. 2, an attempt is also made to connect an IPv6 or IPv4 network 6 through gateways 4 and 5 between a first ZigBee network 2 and a second ZigBee network 3 and allow a ZigBee packet to flow onto the IPv6 or IPv4 network 6, thereby providing communications between ZigBee network devices G, H, I and J, K, L.

JP-A-2005-512461 is available as a related art patent document. It describes a method of routing electronic information to a person using the Internet protocol. Specifically, an address is assigned to a person rather than a device and the person enters the assigned address in a terminal near to the person, whereby a packet addressed to the person is transmitted to the device near the person.

Here, ZigBee is described as one of the interfaces that an apparatus for authenticating personal identification has, but communications based on the IP (Internet Protocol) using a ZigBee network as in the invention are not disclosed.

To selectively connect networks defined based on the IP through a ZigBee network, routing based on the protocol of IPv6 is considered, for example. In this case, it is necessary to discriminate between the ZigBee network and the IPv6 network and transfer control between the networks becomes necessary.

The frame size stipulated by IEEE 802.15.4 is 127 octets and the size of a ZigBee frame is 102 octets. This does not satisfy the minimum MTU (Maximum Transfer Unit) value of IPv6.

The IPv6 header is 40 octets, which is large for an IEEE 802.15.4 network and thus it is inefficient to pass the header through IPv6 as it is. If the header can be compressed, it becomes possible to provide efficient communications. At this point in time, a proposition to allow a packet (header) to pass through IPv6 using a network based on IEEE 802.15.4 is not made.

### SUMMARY OF THE INVENTION

It is therefore an object of the invention to provide a network communication system that can be used for an area where it is difficult to lay network cables, or a system that can still function at the time of a disaster, such as terrorism or an earthquake, during which it cannot be expected that network cables and power supply will normally operate.

In some implementations, a network communication system of the invention comprises:

a ZigBee network being defined based on a network layer of ZigBee;

a plurality of IP (Internet Protocol) networks being defined based on IP; and

a plurality of gateways available for protocols of the ZigBee network and the IP networks,

wherein the plurality of IP networks is connected to the ZigBee network via the plurality of gateways, and
a ZigBee frame that is based on the network layer of ZigBee is transmitted in the ZigBee network, the ZigBee frame storing an IP packet that is based on IP in a part of the ZigBee frame.

### BRIEF DESCRIPTION OF THE DRAWINGS

In the accompanying drawings:

FIG. 1 is a conceptual drawing of a ZigBee network;

FIG. 2 is a conceptual drawing of a network for allowing a packet to flow onto an IPv6 or IPv4 network;

FIG. 3 is a configuration drawing to show an embodiment of the invention;

FIG. 4 is a drawing of a ZigBee frame format example;

FIG. 5 is a drawing of a packet format example of an IPv6 packet;

FIG. 6 is a drawing of a content header format example;

FIG. 7 is a drawing of a configuration example of a gateway 10;

FIG. 8 is a drawing of a static content header format example;

FIG. 9 is a drawing of an application support sublayer frame format example;

FIG. 10 is a drawing of a Frame Control format example in an application support sublayer;

FIG. 11 is a drawing of a ZigBee frame format example;

FIG. 12 is a drawing of a frame format example with ID extended;

FIG. 13 is a drawing of a format example with ID In FIG. 8 extended;

FIG. 14 shows an example of assigning all of five bits of a Reserved field in FIG. 12 to fragment offset;

FIG. 15 is a drawing of a content header format example containing payload length;

FIG. 16 is a drawing of a content header format example using implicit payload length;

FIG. 17 is a schematic representation of a record example in an IPv6 routing table;

FIG. 18 is a schematic representation of a record example in a gateway transfer table;

FIG. 19 is a schematic representation of a record example in an IPv6 routing table specifying a different virtual interface for each destination;

FIG. 20 is a schematic representation of a record example in a gateway table for searching for forwarded gateway from virtual interface identifier;

FIG. 21 is a drawing to show the format of the basic portion of an IPv6 header;

FIG. 22 is a drawing of a configuration example of the gateway 10 installing a mapping table;

FIG. 23 is a schematic representation of an IPv6 packet received by the gateway 10;

FIG. 24 is a schematic representation of an IPv6 packet generated by the gateway 10; and

FIG. 25 is a drawing of a new content header format example.

### DESCRIPTION OF THE PREFERRED EMBODIMENTS

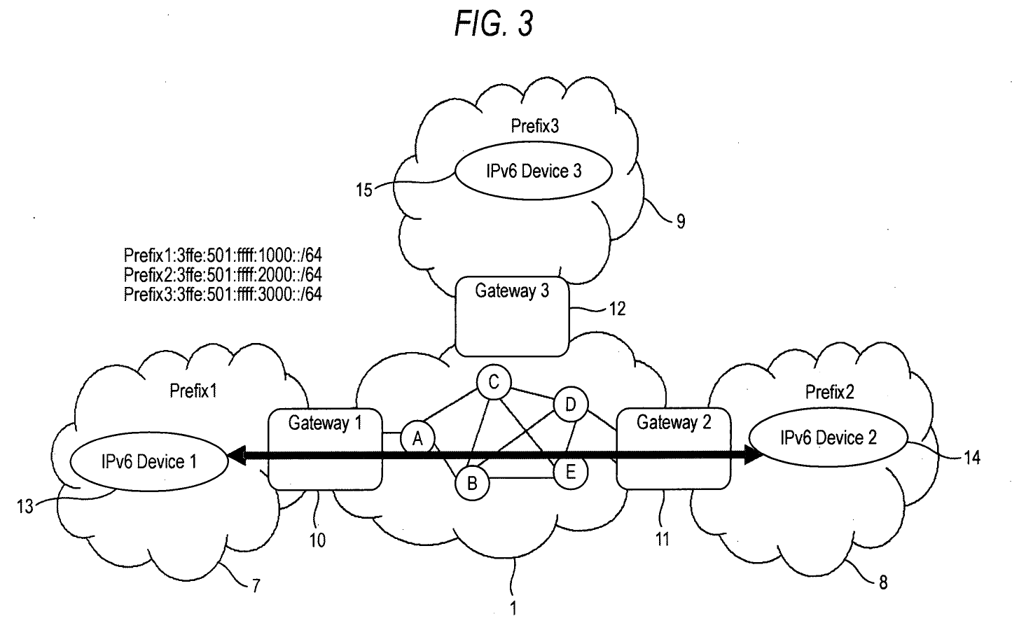

Referring now to the accompanying drawings, a preferred embodiment of the invention will be described. FIG. 3 is a configuration drawing to show an embodiment of the invention and shows an example in which an IP network is configured as IPv6 network. A ZigBee network 1 is connected through gateways 10 to 12 among a first IPv6 network 7, a second IPv6 network 8, and a third IPv6 network 9. Here, it is assumed that the gateways 10 to 12 can use both network protocols of ZigBee and IPv6.

To begin with, the format of a packet will be discussed.

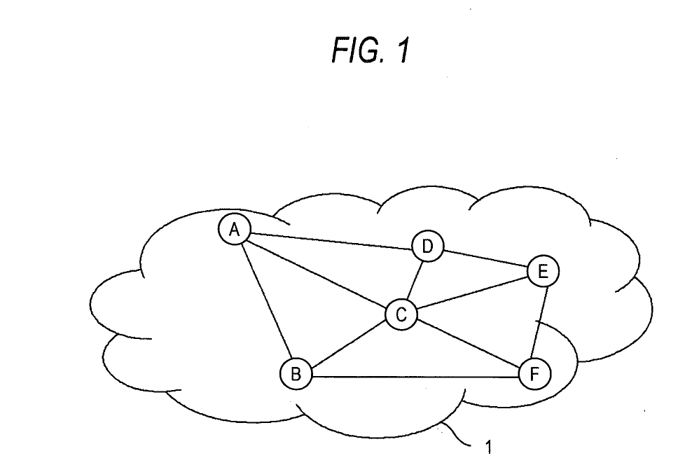

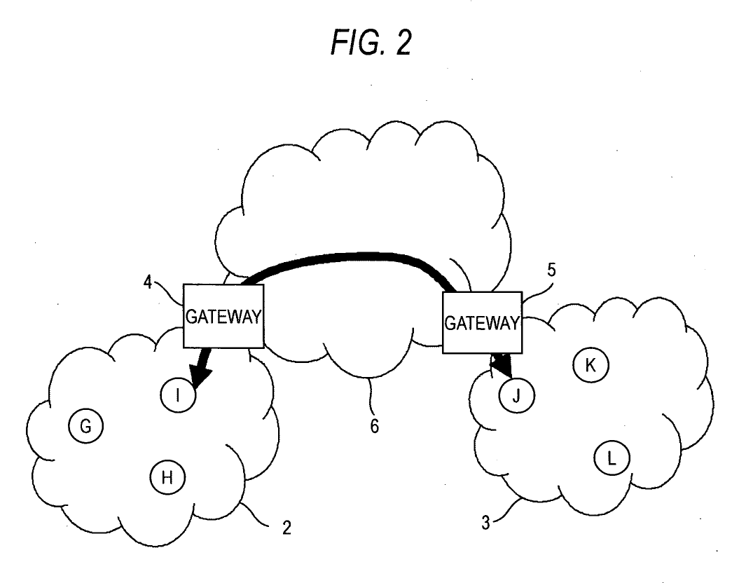

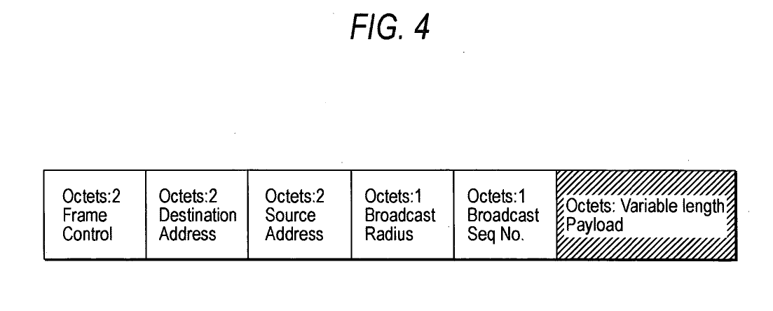

To transfer an IF packet in the network configuration in FIG. 1, it is possible to use a technique of placing the IP packet in a ZigBee frame as it is. The ZigBee frame is represented as in FIG. 4. In FIG. 4, Frame Control indicates that the frame is data. The destination address in the ZigBee network is entered in Destination address, and the sender address in the ZigBee network is entered in Source Address. It is assumed that other fields have appropriate values for enabling the frame to reach the gateway positioned in the destination direction.

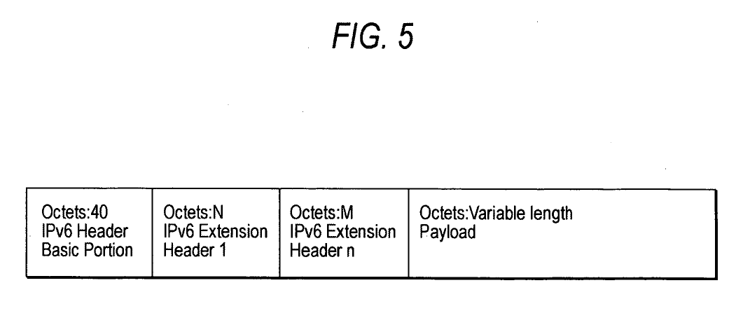

An IPv6 packet as shown in FIG. 5 is stored in a payload portion of the ZigBee network frame format shown in FIG. 4. To provide extendability, a header called a content header is inserted in the beginning of the IPv6 packet. The content header is described later. Sizes N and M of extension headers depend on the types of extension headers.

The sender, gateway, stores an IPv6 packet in the payload portion of the packet and sends the packet to the destination address in the ZigBee network. Referring to FIG. 3, the IPv6 packet received at the gateway 10 is stored in a ZigBee frame and the ZigBee frame is transmitted via the ZigBee network to the gateway 11.

The gateway 11 takes out the IPv6 packet from the payload of the received ZigBee frame and transfers the IPv6 packet to the IPv6 network 8. When transferring the IPv6 packet, the gateway 10 decrements the hop limit in the IPv6 header by one.

If the payload of the IP packet is sufficiently small (for example, 30 octets or less), there is no harm because the IPv6 packet can be stored as it is. Operation would be possible with a network designed for sending very small data.

The case where the IPv6 packet is a size exceeding the payload of the ZigBee frame can occur. Generally, in the IPv6 network, if the packet to be transferred is larger than the MTU value of the network (link) to which the packet is to be transferred, it is required that the device that attempted to transfer the packet transmit an ICMP (Internet Control Message Protocol) v6 Error Message (Packet Too Big) to the sender to provide notification of the transfer destination MTU value.

However, the minimum MTU value which must be guaranteed in IPv6 is 1280 octets and notification of an MTU value smaller than the minimum MTU value (1280 octets) are not sent to the sender. In the ZigBee case, in fact, even a packet smaller than 1280 octets does not fit in the payload of the ZigBee frame. Since an MTU value smaller than 1280 octets cannot be sent to the sender because of the IPv6 specifications, the gateway 10 divides the packet and transfers the packet.

At this time, the gateway 10 can transmit a Packet Too Big message with MTU=1280; however, since the header size for the payload becomes larger, it is efficient not to send the Packet Too Big message. On the other hand, if the size per packet becomes larger, the sizes of the work areas required for dividing a packet and reassembling the packet in the gateway need to be increased. Thus, it is also considered that the user is allowed to set transmission or no transmission of a Packet Too Big message and specify whether or not the specified MTU value is fixed in the system if a Packet Too Big message is transmitted. In the default of IPv6, the packet size on Ethernet (registered trademark) is 1500 octets and thus it is also considered that a 1500-octet MTU is sent as necessary.

The following packet dividing technique can be used regardless of whether or not the Packet Too Big message mentioned above is sent:

When an IPv6 packet is transmitted after dividing the packet, from the gateway 10, the gateway 11 receiving the packet may reassemble the packets into one packet or the IPv6 packet destination device may reassemble the packets into one packet. In the IPv6 protocol, a midway router does not divide a packet and thus following the protocol, the ZigBee network between the gateways 10 and 11 should be put into a black box and the packet entering the gateway 10 should not be divided when it exits from the gateway 11. This means that the gateway 11 should reassemble the packets into one before transferring the packet to the IPv6 network 8. Accordingly, in the receiving side, the need for reassembling packets is eliminated, so that the load required for the processing is lightened. If an IPv6 device 14 in the receiving party assembles packets, for example, an IPv6 header must be added to each of the divided packets and thus the network efficiency worsens.

A technique of putting the ZigBee network into a black box will be discussed. In ZigBee, the specifications for conveying divided data are not defined at this point in time. Then, the technique will be discussed below containing the mechanism for conveying divided data:

(a) Transmitting Party (Gateway 10)

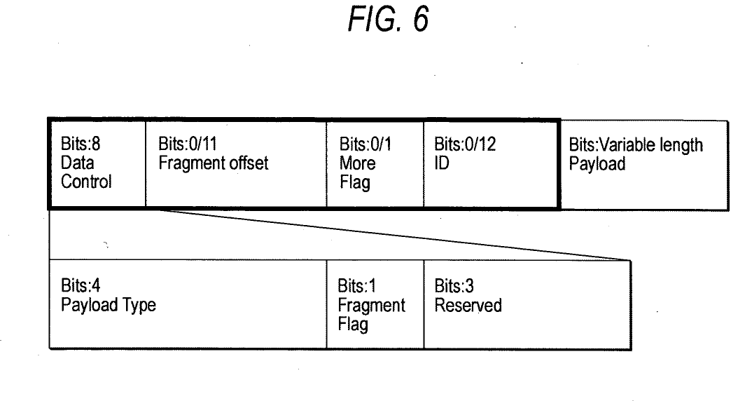

In the beginning of an IPv6 packet, a content header as shown in FIG. 6 is added for transmission. The content header is provided for the gateways 10 to 12 to share information representing the data type entered in the payload of the ZigBee frame.

To begin with, fields of the content header will be discussed.
Data Control field
   Represents the type and the property of the packet following the header.
Fragment offset field
   Indicates which octet the top bit of the payload following the header corresponds to in the original IPv6 packet. The field length is 11 bits because a packet of up to 1500 octets is passed through the ZigBee network as mentioned above. The length depends on the size of IPv6 packet whose transfer is allowed.
More Flag
   Indicates whether or not the packet is the last of the divided packet. If the packet is the last packet, 0 is set; otherwise, 1 is set.
ID field
   If the original packet is divided, an identifier for indicating that the original packet of a sequence of packets is the same is entered in the ID field. The frames matching in the values, the sender address, and the destination address are reassembled into one packet.

Fields of the Data Control field of the content header are as follows:
Payload Type:
   Has a four-bit value and indicates the type of data contained in the payload.
      1 (0001): IPv6
      2 (0010): IPv4
Fragment Flag:
   Indicates whether or not the data contained in the payload is a divided packet.
      0: Undivided packet is contained
      1: Divided packet is contained
   When the value is 1, the content header contains the fragment offset, More Flag, and ID fields. When the value is 0, the content header does not contain these fields.
Reserved
   Unassigned. 0 is stored.
      (b) Receiving Party (Gateway 11)

If the Fragment Flag of the content header of the received packet is 0, the packet is not divided and thus the IPv6 packet contained in the payload following the content header is extracted and is transmitted to the IPv6 network 8.

If the Fragment Flag of the content header of the received packet is 1, the packet is a divided packet and thus is reassembled in the gateway 11. If it is determined that the frames share the same sender address, destination address of the ZigBee network header and the ID of the content header are from the same original packet. The payload portions following the content headers in these frames are assembled according to the offset values of the content headers. The whole length of the IPv6 packet can be found by adding 40 octets to the payload length field contained in the header of the IPv6 packet. The packet into which the frames are reassembled is transmitted to the network 8.

A problem may occur in the IPv6 network 8 connected to the gateway 11 and an error message may be sent to the IPv6 host on the IPv6 network 7 connected to the gateway 10. If the gateway 11 receives such a packet, it transfers an ICMP error message via the ZigBee network 1 to the gateway 10. If the ICMP error message is too large to fit in a frame of the ZigBee network, division and reassembling processing similar to that described above is performed to deliver the packet to the recipient IPv6 address.

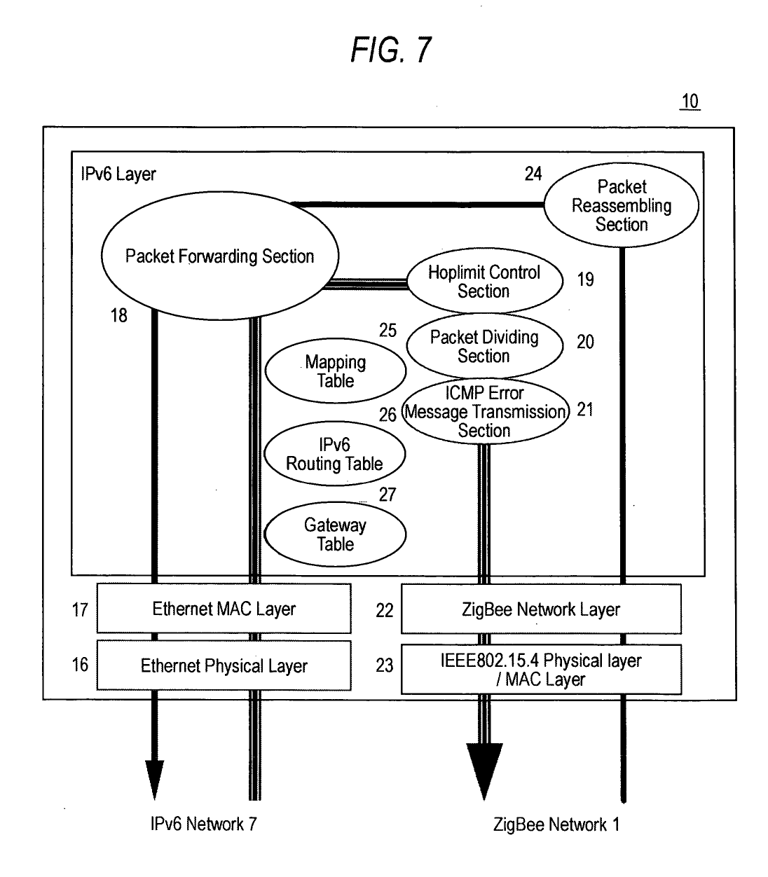

FIG. 7 is a drawing of a configuration example of the gateway 10 (11, 12) used in FIG. 3. IP packet data transmitted from the IPv6 network 7 to the IPv6 network 8 is input to a packet forwarding section 18 through an Ethernet physical layer 16 and an Ethernet MAC layer 17 operating as low-order layers of IPv6 layer, and is also input into a hop limit control section 19. If the size of the IP packet exceeds the payload of the ZigBee frame, a packet dividing section 20 divides the packet into packets of a predetermined size. Then the packets are output to the ZigBee network 1 through an ICMP error message transmission section 21, a ZigBee network layer 22, and an IEEE 802.15.4 physical layer/MAC layer 23. An IPv6 routing table 26 and a gateway table 27 that indicates the forwarded gateway are provided to specify the packet transfer destination as described later.

The hop limit control section 19 decrements the number of hops of each passed packet by one, wherein a hop is defined as the network 1 based on the ZigBee network, in the IP network.

The ICMP error message transmission section 21 can limit the transfer to only the top one frame, so that the transfer efficiency can be enhanced by checking the passage of an ICMP error message.

In contrast, divided IP packet data transmitted from the IPv6 network 8 to the IPv6 network 7 is input to a packet reassembling section 24 through the IEEE 802.15.4 physical layer/MAC layer 23 and the ZigBee network layer 22 and is assembled into the original-size IP packet. The IP packet assembled back to the original size is output to the IPv6 network 7 through the Ethernet MAC layer 17 and the Ethernet physical layer 16.

To select traffic in the gateways 10 to 12, since the band of ZigBee network is narrow, a packet passed through the ZigBee network can be selected for efficiency (optimization). For example, traffic to be passed can be selected according to IPv6 traffic class or a Flow Label field, etc. Packets may be separated into packets to be passed and packets not to be passed by filtering, etc.

The hop limit can also be controlled by the gateway 11 of the receiving party rather than by the gateway 10. It needs to be set whether the transmitting party or the receiving party decrements the hop limit to ensure consistency.

It is desirable that the size of the IPv6 packet allowed by the gateways 10 to 12 should be variable because it is considered to be a tuning item. This is based on the fact that the number of IPv6 headers becoming overhead is affected depending on the value of the MTU entered in a Packet Too Big message that is sent. If the MTU value is small, the IPv6 header occupation ratio increases; if the MTU value is large, a sufficient work area becomes necessary in the gateways 10 to 12 and the delay of each packet grows.

The IPv6 transferring mechanism is described above; the description also applies to IPv4. To pass an Ipv4 packet through ZigBee Network, unless Don't Fragment Flag is set in the original packet, usual IP fragmentation can be executed so that the need for reassembling packets in the receiving party is eliminated. However, an IPv4 header is always added to each of the divided packets and thus overhead is larger. Therefore, it is desirable that a technique similar to that of the invention should be adopted.

The allowed packet size of ICMPV6 Error Message is up to 1280 octets and a larger number of portions of the error source packet are transmitted within the range of the allowed size. Since a 1280-octet packet exceeds 10 frames in terms of ZigBee frames, only the first one frame may be transferred for the sake of efficiency. Therefore, transfer may be made switchable between transfer of the whole ICMPv6 packet and transfer of only some packets.

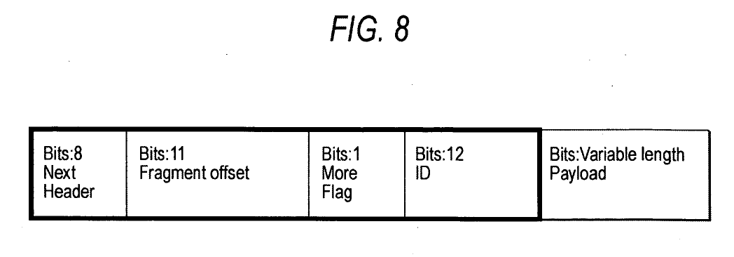

The content header format may be such that a content header uses one octet size IANA protocol assign number in next header field, and fixedly add fragment information. FIG. 8 shows the static content header format.

In FIG. 7, the Ethernet physical layer 16 and the Ethernet MAC layer 17 are shown by way of example, but a wireless network based on IEEE 802.11a, 11b, 11g, Gigabit Ethernet, etc., may be used.

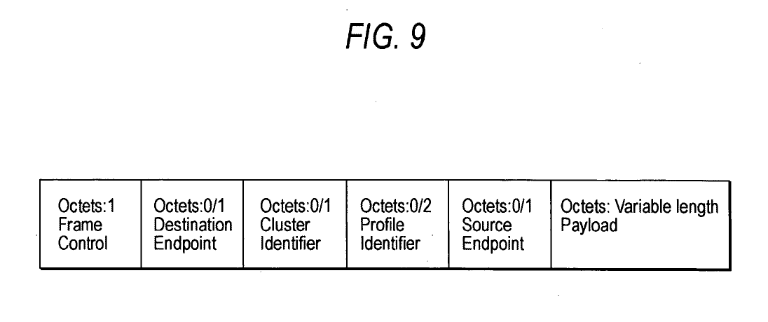

If some ZigBee application needs to be operated on the gateways 10 to 12, the gateways 10 to 12 need to discriminate between a frame for the application and a frame containing IPv6 used in the invention. For this purpose, an application support sublayer of a format as shown in FIG. 9 is used. Specifically, a frame of a format as in FIG. 9 is further stored in the payload portion (hatched portion) previously described with reference to FIG. 4. The header can indicate which processing section data is to be passed to on the node at which the packet arrives.

In the format in FIG. 9, in fact, usual unicast packet is transmitted and thus Source Endpoint becomes unnecessary. This will be discussed in Indirect Address Mode of Frame Control in another application support sublayer. Appropriate values for IPv6 packet transfer function are entered in Recipient Endpoint, Cluster Identifier, and Profile Identifier.

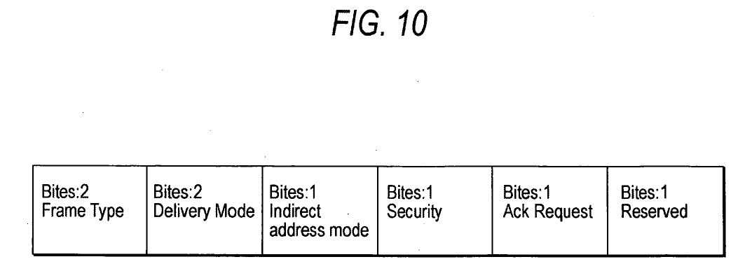

The format of Frame Control in the application support sublayer in FIG. 9 is as shown in FIG. 10. The fields in FIG. 10 have optimum values conforming to the ZigBee specifications and specifically take the following values at this point in time:
Frame Type: 00 (data)
Delivery Mode: 00 (Normal Unicast)
Indirect Address Mode: 0 (Source Endpoint is not required)
Security: 0 (unused. Basically, the value may be 0 or 1. Use as required.)
Ack Request: 0 (not required)
Reserved: 0

Following the content header shown in FIG. 6, an IPv6 packet as shown in FIG. 5 is stored in the payload portion in the application support sublayer in FIG. 9.

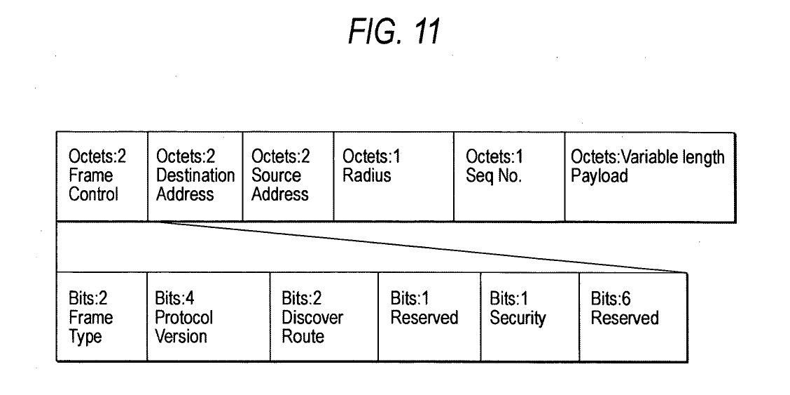

Frame Control in a frame of the ZigBee network layer contains a two-bit frame type subfield for specifying the frame type as shown in FIG. 11. At present, the following values are defined in the subfield:
00: Data
01: NWK command
10-11: Reserved

By assigning a frame 10 or 11 as in the invention to simply pass through the ZigBee network, the need for using application support sublayer for a frame that simply passes through the ZigBee network as mentioned above is eliminated, and efficiency can be increased.

An example of assigning “10” to a packet used for tunneling as mentioned above in the frame type subfield is given below;
00: Data
01: NWK command
10: Tunnel
11: Reserved

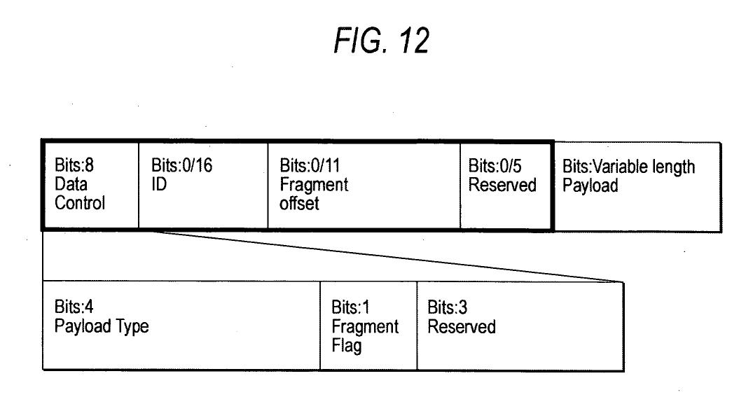

Several suggestions for improving the frame format are shown below: FIG. 12 is a drawing of a content header example with ID in FIG. 6 extended. Fields of Data Control in FIG. 12 are as follows:
Payload Type:
   Has a four-bit value and indicates the type of data contained in the payload.
   1 (0001) IPv6
   2 (0010): IPv4
Fragment Flag: Indicates whether or not the data contained in the payload is a divided packet.
   0: Undivided packet is contained
   1: Divided packet is contained
   When the value is 1, the content header contains the fragment offset and ID fields. When the value is 0, the content header does not contain these fields.
Reserved: Unassigned. 0 is stored.

Next, fields of the content header are as follows:
Data Control field
   Represents the type of packet following the header. The field can be set to a smaller size if IANA definition is not followed.
Fragment offset field
   Indicates what octet of the original IPv6 packet the top bit of the payload following the header corresponds to. The field length requires 11 bits because a packet of up to 1500 octets is passed through the ZigBee network as mentioned above. The length depends on the allowed packet size.
ID field
   If the original packet is divided, an identifier is entered in the ID field for indicating that the original packet of a sequence of packets is the same. The frames matching in the value as well as the sender address and the destination address are reassembled into one packet. The ID uses a number ranging from 0 to 65535 repeatedly.

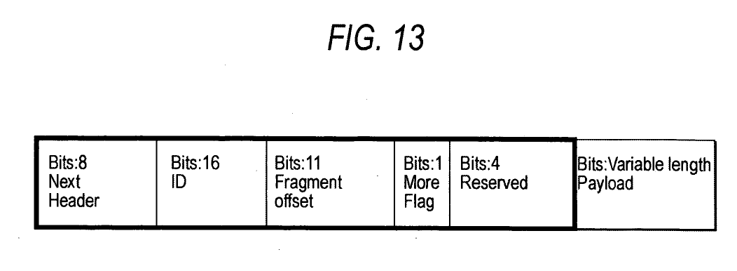

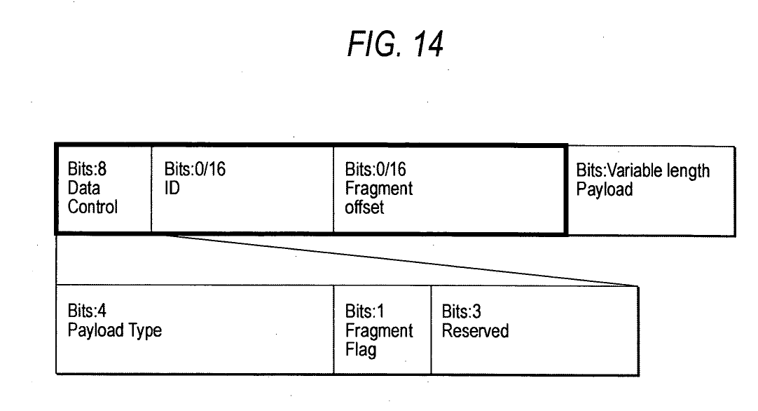

FIG. 13 shows a format with the ID in FIG. 8 extended. In FIG. 12 or 13, 11-bit fragment offset can represent only 0 to 2047. To handle a larger-size packet, it is possible to assign a part of a Reserved field following the More Flag in FIG. 13 to the fragment offset. FIG. 14 shows an example of assigning all of five bits of the Reserved field in FIG. 12 to the fragment offset.

The frame format containing the payload length will be discussed. Each of the frame formats in FIGS. 12 to 14 assumes that the frame length can be acquired according to any mechanism other than the frame and therefore a field in which the payload length is entered is not defined. As a general-purpose solution, the payload length is preferably entered in the frame and thus it is also possible to define a frame that includes the payload length.

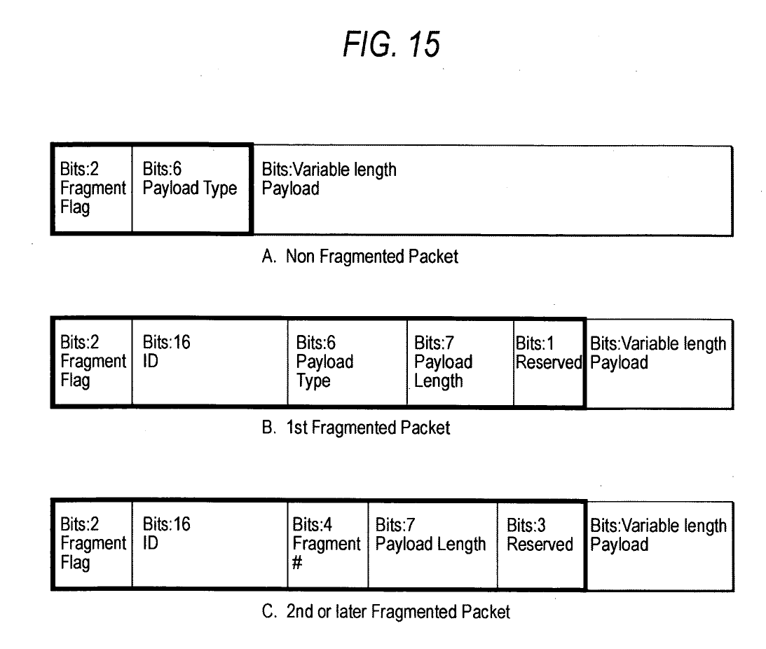

FIG. 15 shows the content header format containing the payload length.
Fragment Flag: Two-bit length
   Indicates whether or not data contained in the payload is a divided packet and indicates the position if the data is a divided packet.
   00: No fragmented packet
   01: First fragmented packet
   10: Last fragmented packet
   11: Intermediate fragmented packet
ID: 16-bit length
   Is the identifier of the original packet. If the values of sender address, destination address, and ID of one frame are the same as the values of another frame, it can be determined that the frames are parts of the same packet. When the maximum number is reached, the field is reset to 0.
Payload Type: Six-bit length
   Indicates the type of data contained in the payload.
   1 (000001): IPv6
   2 (000010); IPv4

The intermediate fragmented packet and the last fragmented packet uses C format.
Fragment #: Four-bit length
   Represents the fragmented frame order. From the value, the offset position can be calculated.
Payload Length: Seven-bit length
   Indicates the payload length of fragmented frame.
Reserved: One-bit or three-bit length
   Filled with “0”

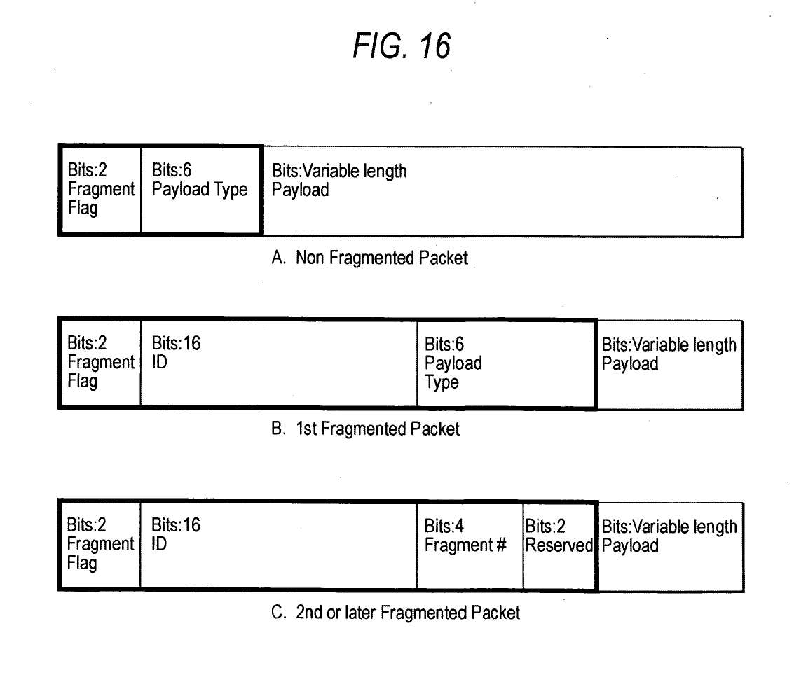

The payload length is entered in the frame format in FIG. 15. However, when fragmentation is required, if data is entered in the payload as much as possible, overhead can be decreased. Therefore, it is natural to define the first fragmented packet or the intermediate fragmented packet as a packet with the maximum data contained in the payload. Here, each of the first fragmented packet and the intermediate fragmented packets are defined as a packet which must have the same size as the maximum value of the frame size, whereby it is made possible to use a frame of the content header format using implicit payload length as shown in FIG. 16.
Fragment Flag: Two-bit length
   Indicates whether or not data contained in the payload is a divided packet and indicates the position if the data is a divided packet.
   00: No fragmented packet
   01: First fragmented packet
   10; Last fragmented packet
   11: Intermediate fragmented packet

The intermediate fragmented packet and the last fragmented packet uses C format.

When the last fragmented packet arrives, the whole packet size can be derived from the IPv6 payload length contained in the first fragmented packet. The offset value can be derived from the fragment order contained in the last fragmented packet. The payload length contained in the last fragmented packet can be calculated from the whole length of the original packet and the offset value. In contrast, when the last fragmented packet arrives, if the first fragmented packet has not arrived, the payload length of the first fragmented packet is handled as 91 octets and when the first fragmented packet arrives, the correct length is calculated. Such calculation is not necessary if the packet length can be found according to any other technique such as finding the frame size at the physical layer level.

If the frame length of the intermediate fragmented packet is not 102 octets, the packet is discarded.
ID: 16-bit length
   Is the identifier of the original packet. If the values of sender address, destination address, and ID of one frame are the same as those of another frame, it can be determined that the frames are parts of the same packet. When the maximum number is reached, the field is reset to 0.
Payload Type: Six-bit length
   Indicates the type of data contained in the payload.
   1 (000001): IPv6
   2 (000010): IPv4
Fragment #: Four-bit length
   Represents the fragmented frame order. From the value, the offset position can be calculated. In any frame other than the last fragmented frame, it is necessary to fill the payload up to the maximum of the frame length.
Reserved: Two-bit or three-bit length
   Filled with “0”

At this point in time, the specifications of the ZigBee network layer do not define any mechanism for conveying divided data. However, when the mechanism is defined in the future, it will be possible to replace the mechanism for dividing and reassembling a packet of the invention with the ZigBee network specifications.

Several examples of available packet formats have been given. Extension, etc., will be discussed below with FIG. 6 as a representative example: Since change in header compression is replacement of IF address field on a packet, similar change can also be applied if any other format is used.

In FIG. 3, for example, the packet addressed to the IPv6 device 14 needs to be delivered to the gateway 11 and the packet addressed to the IPv6 device 15 needs to be delivered to the gateway 12.

Thus, in the invention, each of the gateways 10 to 12 is provided with the IPv6 routing table and the gateway table indicating the forwarded gateway (see FIG. 7). For the gateway table, a dynamically exchanging method and a statically setting method are possible. In the embodiment, a statically setting example will be discussed.

IPv6 routing table record generally has the following information.

a) Destination Address

Is the packet destination address and indicates the address to which the record applies. The packet is transferred in conformity with transfer information indicated in the record if the destination address of the packet to be transferred matches the high-order N bits of the address. Here, N of the N bits is the value specified by the destination address prefix length described just below:

b) Destination Address Prefix Length (Net Mask)

Indicates which part of the destination address specified in a) the record applies to.

c) Next Hop Address

If the destination address of the packet to be transferred matches the destination address specified in a) in the high-order bits as much as the length specified in b), the address of the gateway to which the packet is to be transferred is set. In fact, the address of the next hop router, the address of the lower layer of a neighboring node, the interface name, and the like are also stored (16 octets or more). In addition, information indicating which network interface each next hop connects to and the like are also contained.

Each gateway table record has at least the following items:

a) Destination Address

Is the packet destination address and can be specified in terms of network address (prefix) units or host address units. The prefix can also be specified in a block using the following destination address prefix length (16 octets or more):

b) Destination Address Prefix Length

Indicates which part of the destination address specified in a) the record applies to. For example, if the destination address of the packet to be transferred matches the destination address specified in a) in high-order 64 bits, 64 is set as the destination address prefix length for transferring the packet to the gateway specified in the record. Likewise, if the destination addresses match in all of 128 bits, 128 is specified (one octet or more).

c) Forwarded Gateway

If the destination address of the packet to be transferred matches the destination address specified in a) in the high-order bits as much as the length specified in b), the ZigBee address of the gateway to which the packet is to be transferred is set (2 octets or more).

If the next hop in the routing tables towards the destination address is a gateway which is described in an embodiment of this invention, a virtual interface is specified rather than directly writing the address of the gateway in the routing information. If the virtual interface is specified as the next hop, the gateway searches the gateway table for the transfer destination, replaces compression address for the packet if necessary as described later, performs packet dividing processing if necessary, and transfers the packet to the gateway of the next hop.

In FIG. 3, a procedure of delivering the packet addressed to the IPv6 device 14 transmitted from the IPv6 device 13 to the gateway 11 will be discussed. It is assumed that the devices and the networks in FIG. 3 have the following addresses:

IPv6 network 7 Prefix 1; 3ffe:501:ffff:1000::/64

IPv6 network 8 Prefix 2: 3ffe:501:ffff:2000::/64

IPv6 network 9 Prefix 3: 3ffe:501:ffff:3000::/64

IPv6 device 13; 3ffe:501:ffff:1000::f

IPv6 device 14: 3ffe:501:ffff:2000::f

IPv6 device 15: 3ffe:501:ffff:3000::f

Gateway 10_IPv6: 3ffe:501:ffff:1000::1

Gateway 10_ZigBee: 0x1001

Gateway 11_IPv6; 3ffe:501:ffff:2000::2

Gateway 11_ZigBee: 0x1002

Gateway 12_IPv6: 3ffe:501:ffff:3000::3

Gateway 12_ZigBee: 0x1003

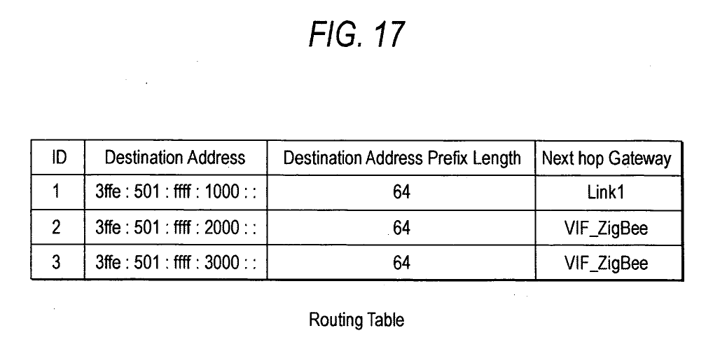

The gateway 10 has records as in FIG. 17 in the IPv6 routing table. Here, the record of ID 1 indicates that 3ffe:501:ffff:1000::/64 is the network to which the actual interface of the gateway 10 is attached.

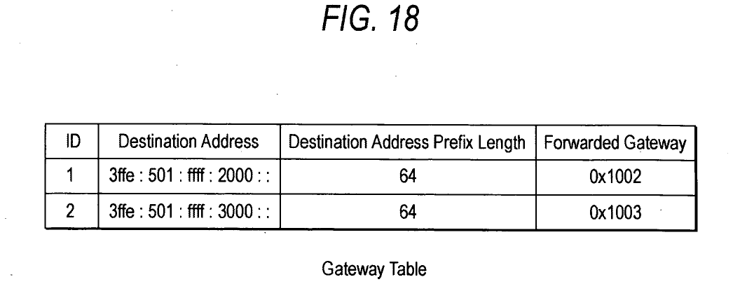

The gateway 10 has records as in FIG. 18 in the gateway table. Here, the record of ID 1 indicates that the packet addressed to 3ffe:501:ffff:2000::/64 is to be transferred to the gateway 11.

The processing sequence is as follows:

1) The IPv6 device 13 transmits a packet A to the IPv6 device 14.

2) The packet A arrives at the gateway 10.

3) The gateway 10 searches the IPv6 routing table in the gateway 10 and obtains virtual interface “VIF_ZigBee” as the next hop.

4) The gateway 10 searches the gateway table in the gateway 10 and obtains ZigBee address “0x1002” of the gateway 11 as the transfer destination.

5) The gateway 10 divides the packet as described above as required.

6) The gateway 10 puts the packet in a ZigBee network frame and transmits it to the gateway 11.

7) The gateway 11 reassembles packets as required, searches the IPv6 routing table in the gateway 11, and transfers the packet to the appropriate next hop. In the example, the gateway 11 acquires the MAC address of the IPv6 device 14 and transfers the packet to the address.

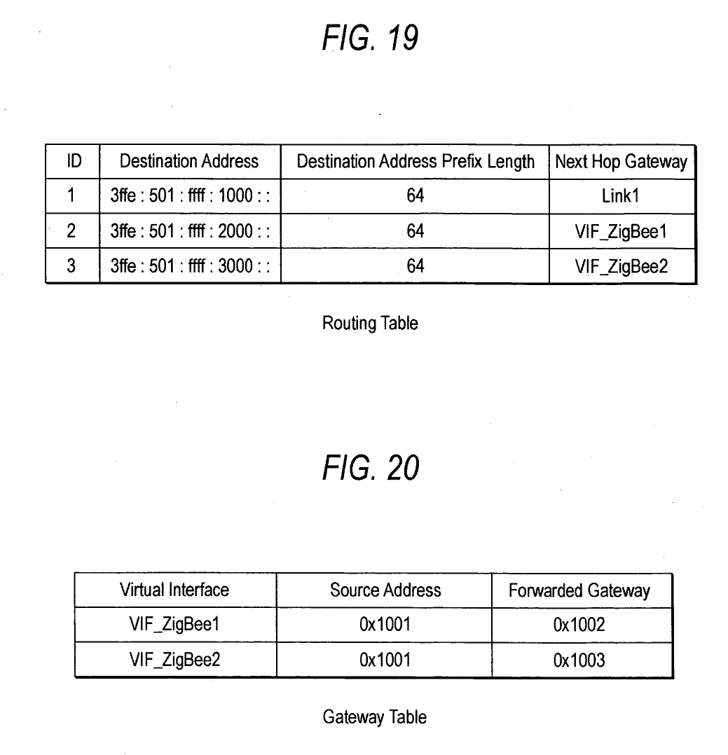

FIG. 19 shows another example of a routing table and FIG. 20 shows another example of a gateway table. In the example, the corresponding virtual interface is changed in response to the destination address, and the gateway to which the packet is to be transferred can be found uniquely from the virtual interface found from the routing table. In such a case, the gateway table need not necessarily be a table and the recipient or sender address can also be specified by the virtual interface.

In the above-described embodiment, the virtual interface is specified in the routing table in the gateway for transferring the packet and the gateway is made to search the gateway table and obtains the address of the gateway to which the ZigBee packet is to be transferred from the gateway table. However, the ZigBee transfer destination address can also be written directly into the routing table in some gateways. In this case, the gateway table becomes unnecessary.

The receiving gateway can search the routing table or the gateway table before assembling packets, thereby determining whether or not the packets are to be transferred again to another gateway. If a divided frame sequence needs to be transferred again, packet assembling leads to overhead. therefore, whether or not transfer is required is determined based on the top packet. Later, the divided packets are transferred intact if it is determined that a sequence of packets from the ZigBee destination address, the sender address, and the fragment ID all come from the same packet.

When the number of IPv6 network prefix that can be transferred by one gateway increases or if the prefix of the connected IPv6 network is changed, combination information of a gateway and the IPv6 prefix that can be transferred by the gateway may automatically update. Accordingly, the maintenance cost can be reduced. The advantage is large particularly when the number of gateways increases.

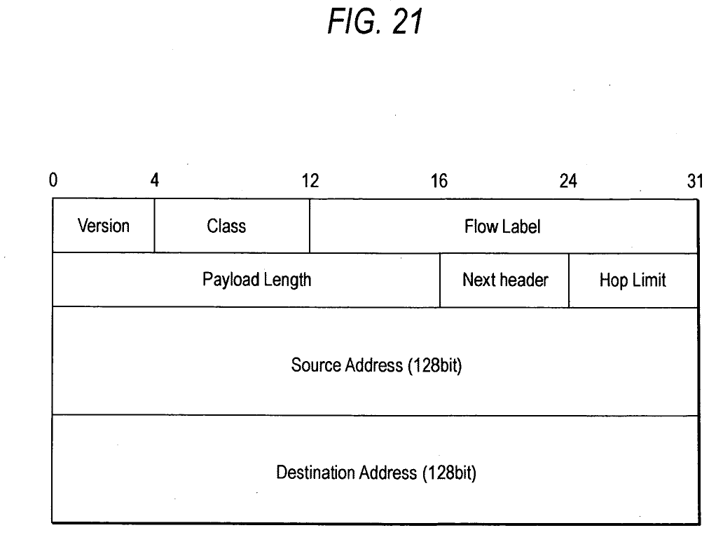

FIG. 21 is a drawing that shows the format of the basic portion of the IPv6 header. In the basic portion of the IPv6 header (40 octets), SenderAddress is 16 octets and Destination address is 16 octets, thereby comprising 32 octets in total −80% of the basic portion of 40 octets. If the address fields can be reduced, efficiency of communications can be accomplished. Specifically, a method of setting the transmission and reception IPvG addresses in the IPv6 header to two octets for shrinking the IPv6 header will be discussed below:

To statically assign a two-octet address to the IPv6 16-octet (128-bit) address, manual assignment is executed in each of the gateways 10 to 12, for example. The number of numbers that can be represented in two octets is 65, 536, which is an overwhelmingly small number as compared with the number of numbers that can be represented as IPv6 addresses. However, 65, 536 addresses may provide a sufficient address space if the use is limited.

Specifically, assuming that the devices in FIG. 3 have the following addresses:

IPv6 device 13: (3ffe:501:ffff:1000::f)

IPv6 device 14: (3ffe:501:ffff:2000::f)

IPv6 device 15: (3ffe:501:ffff:3000::f)

the following two-octet addresses are assigned to the addresses:

IPv6 device 13: (3ffe:501:ffff:1000::f)->0x000a

IPv6 device 14: (3ffe:501:ffff:2000::f)->0x000b

IPv6 device 15: (3ffe:501:ffff:3000::f)->0x000c

At this time, 0x000a, 0x000b, and 0x000c need to be addresses not assigned in the ZigBee network. This means that one two-octet address must not be assigned to two or more IPv6 addresses. If any other IPv6 device for communicating beyond the ZigBee network exists, it is registered in a similar manner.

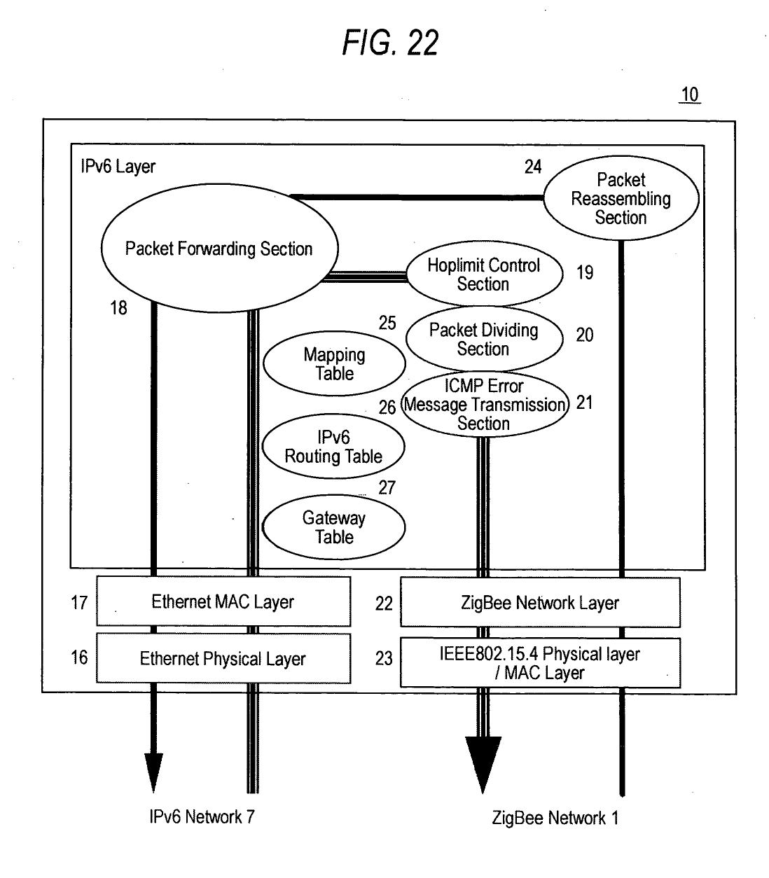

Necessary addresses are assigned in all gateways; the address assignments should be the same in every gateway. This assignment information database is called a mapping table. FIG. 22 shows a configuration example of the gateway 10. A mapping table 25 functions as a database for statically assigning two-octet addresses, for example, to IPv6 16-octet (128-bit) addresses. The compressed address length assigned to each IPv6 address is not limited to two octets and can be increased or decreased in response to the use. Assuming that all gateways have the same mapping table, the actual operation is as follows:

(a) The IPv6 device 13 transmits a packet to the IPv6device 14. This packet is called packet A.

(b) The packet A arrives at the gateway 10.

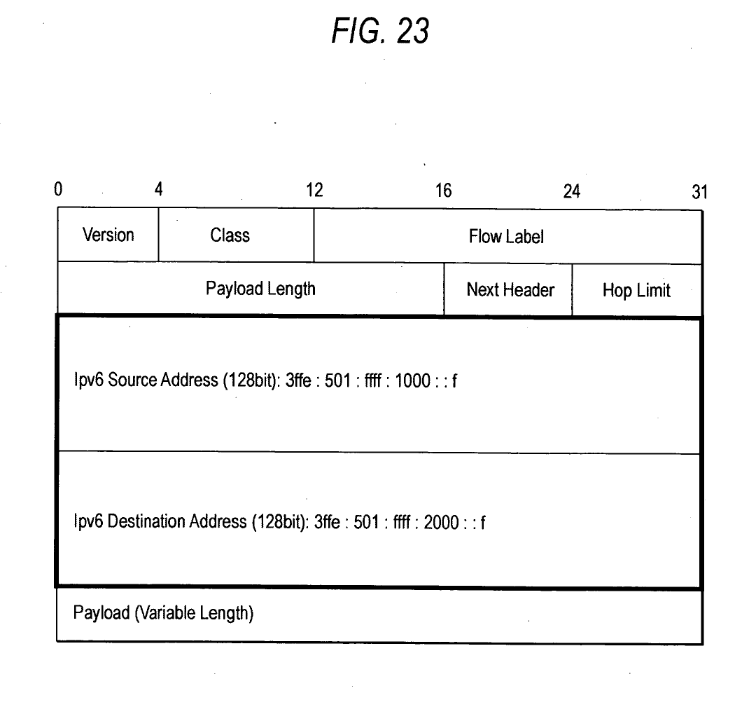

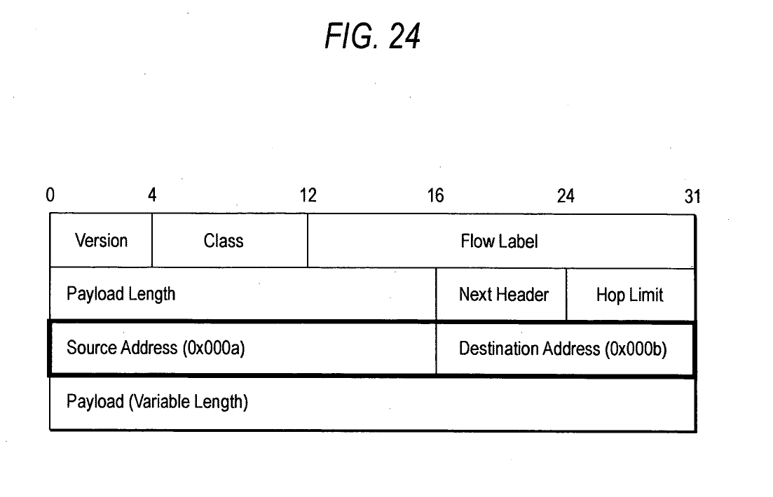

(c) The gateway 10 receives IPv6 packet in FIG. 23 and generates the packet in FIG. 24. The packet has two-octet addresses which replaces the sender and recipient IPv6 address, and the packet is called packet B. The difference between the packets A and B becomes 28 octets. This means that the packet B is 30% of the packet A.

(d) The gateway 10 adds a content header to the ZigBee header and further adds the packet B to the payload portion. FIG. 6 shows the content header, for example. The ZigBee frame is transferred to the ZigBee network. The frame is delivered to the gateway 11 by the function of the ZigBee network layer. Processing when content header and packet dividing become necessary may be performed after address replacement is executed.

(e) The gateway 1 extracts the packet B from the received ZigBee frame and reassembles the packet if necessary. The gateway 11 replaces the addresses in the extracted packet B with the sender address and the destination addresses of the actual IPv6 addresses according to the mapping table to reproduce the packet A, and transmits the packet A to the second IPv6 network 8.

If it is assumed that the IPv6 packet from the ZigBee network is a packet subjected to such address replacement, the gateway 11 can unconditionally enter address replacement processing. However, if the content header contains an identifier capable of indicating the header format so that address replacement need not be used, another header format may be used later so that more extensibility and general versatility can be provided. Specifically, a Payload Type value is assigned that indicates that a packet with a format like packet B is contained.

Using the content header in FIG. 6, any of the following values is assigned to Payload Type:

Payload Type: Is a four-bit value and indicates the type of data contained in Payload.

1 (0001): IPv6

2 (0010): IPv4

3 (0011): IPv6 Compressed Header (format of packet B)

(f) ICMP Error Message

In the second IPv6 network 8, if the transferred IPv6 packet causes an ICMPv6 Error Message because of some problem, the error is handled as follows:

If the ICMPv6 message is transmitted from the intermediate router, the address of the router may be unregistered. Then, the gateway 11 first sends the packet intact without address replacement by default.

Next, if the address of the router is registered in the mapping table and address replacement can be executed, address replacement in the IPv6 header is executed

Further, the original packet is contained in the payload of the ICMPv6 Error Message. Therefore, the gateway 11 can replace the IPv6 header in the payload of ICMPv6. However, checking the contents of the payload by the gateway leads to an increase in the load on the gateway and thus the address in the IPv6 header in the payload is replaced only as required.

In the description given above, the address size is two octets, but the address size can also be smaller in a scalability, the address size can also be enlarged.

In the description given above, similar settings are made in all gateways as the mechanism for distributing the setup address to other gateways, but it is also possible to transfer the address assignment rule set in one gateway to the other gateways.

In the description given above, addresses are assigned statically, but it is also possible to dynamically assign addresses (temporary address). In such a case, the assigned address rule needs to be sent to other gateways.

In the description given above, a Payload Type value is assigned that indicates that a packet with a format like packet B is contained. However, it is also possible to enter the IPv6 value in Payload Type in the content header and provide a flag in the content header indicating that the address is compressed.

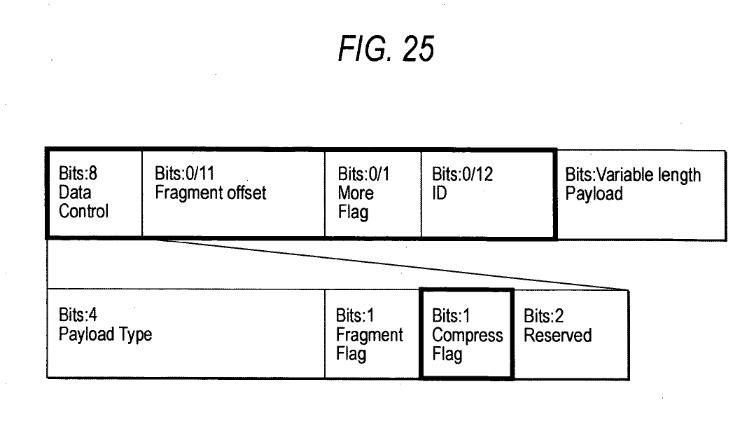

FIG. 25 is a schematic representation of such a new content header format. The format in FIG. 25 differs from that in FIG. 6 only in fields of Data Control and therefore only the fields of Data Control will be discussed.
Payload Type:
   Is a four-bit value and indicates the type of data contained in the Payload.
   1 (0001): IPv6
   2 (0010): IPv4
Fragment Flag:
   Indicates whether or not the data contained in the Payload is a divided packet.
   0: Undivided packet is contained
   1: Divided packet is contained
   When the value is 1, the content header contains the fragment offset, More Flag, and ID fields. When the value is 0, the content header does not contain the fields.
Compress Flag:
   Indicates whether or not the address field of the header is replaced with two-octet entry.
   0: Usual 16-octet address is used.
   1: Compressed address is used.
Reserved:

Unassigned. 0 is stored.

Accordingly, in the present invention, even in an environment where it is difficult to lay IPv6 network cables, a plurality of ZigBee devices is placed at intervals for enabling the devices to communicate with each other, whereby the IPv6 networks can be connected.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A network communication system comprising:
a ZigBee network being defined based on a network layer of ZigBee;
a plurality of IP (Internet Protocol) networks being defined based on IP; and
a plurality of gateways available for protocols of the ZigBee network and the IP networks,
wherein the plurality of IP networks is connected to the ZigBee network via the plurality of gateways, and
a ZigBee frame that is based on the network layer of ZigBee is transmitted in the ZigBee network, the ZigBee frame storing an IP packet that is based on IP in a part of the ZigBee frame.

2. The network communication system as claimed in claim 1, wherein the gateway includes:
a packet dividing section for dividing the IP packet into a plurality of divided IP packets for transmission so that each divided IP packet fits in a payload of the ZigBee frame; and
a packet assembling section for assembling the divided IP packets in reception.

3. The network communication system as claimed in claim 1, wherein the gateway includes an IPv6 (Internet Protocol version 6) routing table and a gateway table that indicates a forwarded gateway.

4. The network communication system as claimed in claim 3, wherein the IPv6 routing table includes a destination address of the IP packet, prefix length data of the destination address, and a next hop address at least.

5. The network communication system as claimed in claim 3, wherein the gateway table includes a destination address of the IP packet, prefix length data of the destination address, and a forwarded gateway address at least.

6. The network communication system as claimed in claim 1, wherein a header address of the IP packet is compressed.

7. The network communication system as claimed in claim 6, wherein each of the plurality of gateways compresses and decompresses the header address of the IP packet.

8. The network communication system as claimed in claim 6, wherein the plurality of gateways shares a common database for compressing and decompressing the header address of the IP packet.

9. The network communication system as claimed in claim 8, wherein the common database is a mapping table.

10. The network communication system as claimed in claim 6, wherein the gateway sets a compression rule of the header address of the IP packet and forwards the set compression rule to another gateway.

11. The network communication system as claimed in claim 6, wherein the gateway automatically assigns a temporary address to the header address of the IP packet for compression of the header address, and forwards a rule of the assignment to another gateway.

12. The network communication system as claimed in claim 1, wherein the gateway includes a hop-limit control section for decrementing a hop number of a packet that passes through the gateway while regarding the ZigBee network as one hop in the IP network.

13. The network communication system as claimed claim 1, wherein the gateway includes an ICMP (Internet Control Message Protocol) error message transmission section that detects an ICMP error message, and selectively forwards ICMP error message data.

14. The network communication system as claimed in claim 3, wherein at least one of the IPv6 routing table or the gateway table is dynamically generated by the gateway.
